(19) United States
(12) Patent Application Publication
(10) Pub. No.: US 2014/0355623 A1
(43) Pub. Date: Dec. 4, 2014

(54) Transmission Control Protocol (TCP) Connection Control Parameter In-Band Signaling

(71) Applicant: FutureWei Technologies, Inc., Plano, TX (US)

(72) Inventors: John Waclawsky, Bartlett, IL (US); Xianjun He, Shenzhen (CN)

(21) Appl. No.: 13/908,954

(22) Filed: Jun. 3, 2013

(51) Int. Cl. H04L 29/06; H04L 1/16

(52) U.S. Cl. CPC H04L 69/163; H04L 1/1642
USPC 370/465

(57) ABSTRACT

Destination endpoints can use in-band signaling to adjust TCP parameters, to adjust entries in history and profile tables, to initialize a transition to an in-band communication mode, or to communicate short flows and/or alerts to a mobile device. A destination endpoint achieves in-band singling by embedding sequence number patterns in acknowledgement (ACK) messages, or by transmitting ACK messages (duplicates or otherwise) in accordance with an ACK sequence pattern. The sequence number or ACK sequence pattern can be pre-associated with any in-band communication message, such as a request to adjust TCP parameters, the reporting of a network or triggering condition, a request to adjust entries in a history or profile table, an indication to transition from a normal communication mode to an in-band communication mode, etc.

### TECHNICAL FIELD

The present invention relates generally to communications, and in specific embodiments, to communicating connection control parameters through in-band signaling.

### BACKGROUND

The Transmission Control Protocol (TCP) is a core protocol corresponding to the transport layer of Internet Protocol (IP) suite, which serves as an intermediate layer between the application layer (e.g., the program) and the internet protocol (IP) layer. TCP provides reliable and ordered delivery of data from one program on one computer to another program on another computer, and is used by major Internet applications, e.g., browsing, email, file transfer, etc.

Modern day TCP algorithms are typically designed to address specific issues (e.g., congestion control, throughput, latency, fairness, quality of service (QoS), wireless compatibility, etc.), and consequently may perform better under some network conditions than others. For instance, a faster error recovery (FACK) TCP algorithm designed to effectively control congestion in wire-line networks may not perform well in wireless networks due to being unable to distinguish between congestion related packet loss (e.g., packets dropped from an overflowing buffer, etc.) and non-congestion related packet loss (e.g., packet not received correctly due to interference, packet corruption, signal fading, drop outs, etc.). Similarly, a detection of out-of-order (DOOR) TCP algorithm designed for efficiently handling re-ordered packets may be unable to efficiently maintain network objectives related to throughput, traffic priority, fairness, and/or Quality of Service.

Conventional networks implement a single/static TCP algorithm on a given piece of network equipment (e.g., a router, switch, etc.) such that all TCP connections constructed or operated by that piece of network equipment comply with a common set of TCP parameters (as defined by the TCP algorithm configured on the device). As a result, conventional TCP algorithms may be incapable of adapting to constantly changing usage demands which may be caused by, inter alia, packet flows changing to cross different networking environments at different times.

### SUMMARY OF THE INVENTION

Technical advantages are generally achieved, by embodiments of this disclosure which describe transmission control protocol (TCP) connection control parameter in-band signaling.

In accordance with an embodiment, a method for in-band signaling is provided. In this example, the method includes receiving one or more packets over a TCP connection extending between a source endpoint and a destination endpoint, embedding a sequence number pattern in one or more acknowledgment (ACK) messages, and sending the one or more ACK messages to the source endpoint. The sequence number pattern is pre-associated with an in-band signaling message. An apparatus for performing this method is also provided.

In accordance another embodiment, yet another method for in-band signaling is provided. In this example, the method includes receiving one or more packets over a TCP connection extending between a source endpoint and a destination endpoint, and transmitting ACK messages to the source endpoint in accordance with an ACK sequence pattern. The ACK sequence pattern is pre-associated with an in-band signaling message. An apparatus for performing this method is also provided.

In accordance with another embodiment, yet another method for in-band signaling is provided. In this example, the method includes transmitting one or more packets over a TCP connection extending between the source endpoint and a destination endpoint, receiving one or more ACK messages, and detecting a sequence number pattern or an ACK sequence pattern conveyed by the one or more ACK messages. The sequence number pattern or the ACK sequence pattern is pre-associated with an in-band signaling message. An apparatus for performing this method is also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of a network architecture of TCP connections;

FIG. 2 illustrates a diagram of a typical TCP transmission activity sequence;

FIG. 3 illustrates a diagram of an embodiment of a network architecture of TCP connections;

FIG. 4 illustrates a diagram of another embodiment of a network architecture of TCP connections;

FIG. 5 illustrates a diagram of an embodiment middlebox;

FIG. 6 illustrates a flowchart of an embodiment method for adjusting TCP parameters through in-band signaling;

FIG. 7 illustrates a flowchart of another embodiment method for adjusting TCP parameters through in-band signaling;

FIG. 8 illustrates a flowchart of yet another embodiment method for adjusting TCP parameters through in-band signaling;

FIG. 9 illustrates a flowchart of an embodiment method for adjusting entries in a history or profile table through in-band signaling;

FIG. 10 illustrates a flowchart of an embodiment method for adjusting entries in a history or profile table through in-band signaling;

FIG. 11 illustrates a flowchart of an embodiment method for transitioning into an in-band communication mode;

FIG. 12 illustrates a flowchart of another embodiment method for transitioning into an in-band communication mode; and

FIG. 13 illustrates a block diagram of an embodiment communications device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims. Aspects of this disclosure may be applied to various communication protocols. Notably, while much of this disclosure is discussed in the context of transmission control protocol (TCP), embodiments discussed herein may be applied to any communication protocol. Indeed, aspects of this disclosure may be particularly useful for protocols in which signaling overhead for control/manipulation of communication parameters has a significant impact on network performance.

Techniques for dynamically optimizing TCP connections are disclosed in U.S. Non-Provisional application Ser. No. 13/802,329 filed on Mar. 13, 2013, entitled “Dynamic Optimization of TCP Connections,” which is incorporated herein by reference as if reproduced in its entirety. One such technique includes adjusting TCP parameters for existing TCP connections in accordance with various criteria, e.g., traffic flow characteristics, network characteristics, etc. The TCP connection typically extends from a source endpoint to a destination endpoint. While the TCP connection may be bi-directional, the forward and reverse paths operate independently, and may even take different paths through the network. As discussed herein, the term TCP connection refers to the forward path unless otherwise specified.

Adjustments to TCP parameters (e.g., varying transmission rate, switching from one TCP algorithm to another, etc.) is typically controlled by the TCP source endpoint, which operates independently from the TCP destination endpoint. However, in some situations it may be desirable for the TCP destination endpoint to have the capability to adjust (or to request adjustment of) TCP connection parameters. One approach for achieving such a capability is to establish a separate control channel between the TCP endpoints to carry TCP parameter adjustment requests. However, a separate control channel may consume network resources (e.g., bandwidth, processing, etc.) and reduce overall network efficiency. Accordingly, an alternative mechanism for allowing TCP destination endpoints to adjust TCP connection parameters is desired.

Aspects of this disclosure allow destination endpoints to adjust (or request adjustment of) TCP parameters through in-band signaling. More specifically, a destination endpoint achieves in-band singling by communicating acknowledgment (ACK) messages in a fashion that triggers adjustment of TCP parameters by the source endpoint. In one embodiment, in-band signaling is achieved through embedding sequence number patterns in acknowledgment (ACK) messages. In another embodiment, in-band signaling is achieved by transmitting ACK messages (duplicates or otherwise) in an ACK sequence pattern. The sequence number or ACK sequence pattern may be pre-associated with a TCP adjustment request or triggering condition, and consequently may elicit TCP parameter adjustment by the source endpoint. For example, a source endpoint may interpret a received sequence number or ACK sequence pattern as a request to adjust one or more TCP parameters, e.g., increase/decrease a transmission rate, pause/resume transmission, adjust a TCP packet size, switch from one TCP congestion control algorithm to another, etc. Alternatively, a source endpoint may interpret a received sequence number or ACK sequence pattern as reporting a triggering condition (e.g., a congestion condition, a characteristic of a destination network, etc.) that causes the source endpoint to adjust one or more TCP parameters. In an embodiment, the sequence number or ACK sequence pattern may communicate that a destination network or address is associated with a certain network environment, such as a wireless network environment, a reordering environment, a fat-pipe environment, or any other network environment. In another embodiment, the sequence number or ACK sequence pattern is associated with an in-band signaling message. The in-band signaling message may include a text message (e.g., when the source endpoint is a mobile device), or an alert (e.g., an amber alert).

Additionally, in-band signaling may also be used to modify entries in a history or status table. A history table may be used to associate one or more characteristics with a destination or source address. By way of example, a history table may associate a particular source address with a wireless network environment. A profile table may be used to assign/re-assign a TCP congestion control algorithm to a new/persistent connection. The history and profile tables may be used in tandem to decide how to manage TCP parameters when communicating a traffic flow. In one example, a source endpoint may interpret a received sequence number pattern or ACK sequence pattern as a request to create, delete, or modify an entry in a profile or history table.

Furthermore, in-band signaling may also be used to initialize a transition from a normal communication mode to an in-band communication mode. For example, the destination endpoint may send a certain sequence number pattern ACKs sequence pattern to prompt the source endpoint to transition from the normal communication mode to the in-band communication mode (or vice versa). While in the normal communication mode, ACK messages may be used to verify whether or not packets are successfully received. During the in-band communication mode, ACK messages may be used to adjust TCP parameters and/or entries in profile/history tables. Further, during the in-band communication mode, in-band signaling (e.g., ACK sequence patterns, etc.) may be used to manipulate associations (e.g. the meanings) of sequence number or ACK sequence patterns during the normal communication mode (or during the any other communication mode). By way of example, an association or meaning of a given ACK sequence pattern may be changed from “reduce the TCP transmission rate” to “pause TCP transmission” during periods of high congestion. Implementation of the in-band communication mode may allow in-band signaling to include shorter sequence number patterns and/or ACK sequence patterns by virtue of not having to facilitate (or otherwise be differentiated from) traditional ACK/NACK signaling.

Advantageously, the in-band signaling techniques of this disclosure effectively piggyback TCP adjustment control information on existing ACK messages (e.g., messages that are already being communicated to verify packet reception), thereby providing the destination endpoint with TCP adjustment functionality without significantly increasing overhead associated with the TCP connection. Notably, the ACK messages may be sent as separate messages, or otherwise piggybacked to TCP messages communicated over the reverse TCP connection.

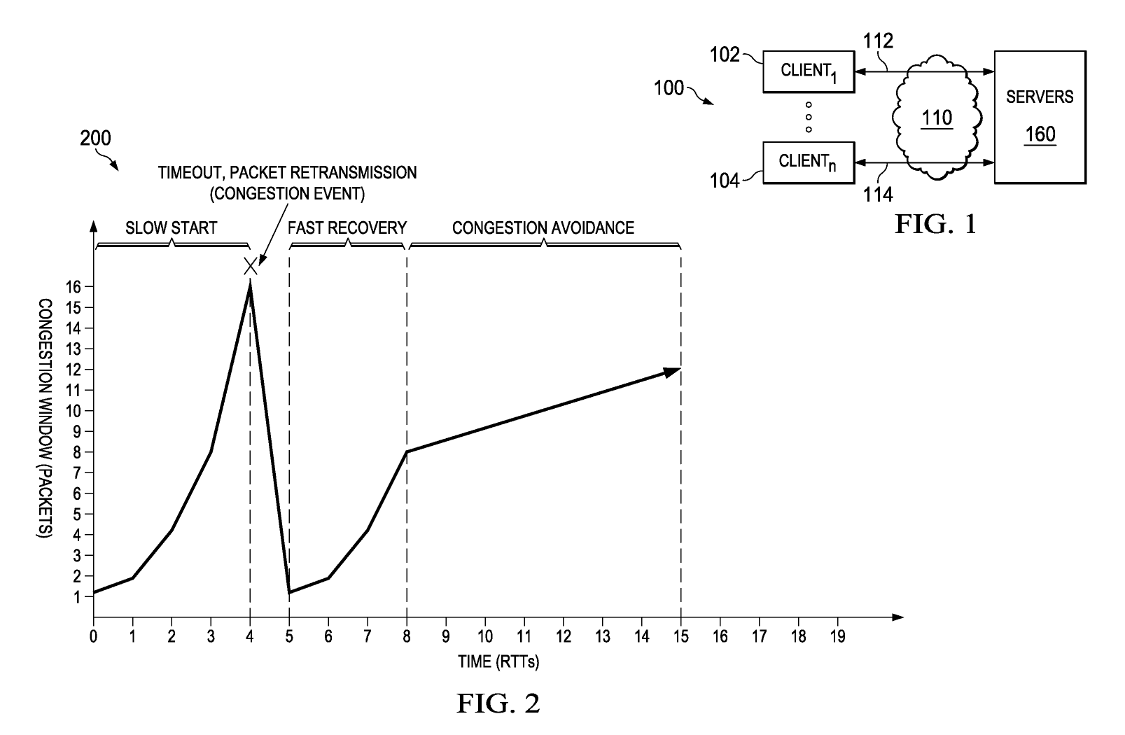

FIG. 1 illustrates a network architecture 100 comprising a plurality of clients 102-104, a network 110, and one or more servers 160. As shown, the client 102 sends/receives data over network 110 via a TCP connection 112, while the client 104 sends/receives data over the network 110 via a TCP connection 114. The TCP connections 112-114 may be constructed and de-constructed each time a TCP session is initiated between the clients 102-104 and one or more servers 160. Alternatively, the TCP connections 112-114 may be persistent TCP connections.

TCP algorithms may operate by increasing/decreasing their transmission rate (e.g., window size) to manage or avoid congestion. FIG. 2 illustrates a TCP transmission sequence 200, as may occur between a client and a server. Notably, transmission rates may be expressed in packets per round trip time (RTT), which is the length of time it takes for an acknowledgment to be received following the transmission of a packet. Further, the TCP transmission sequence 200 is included herein merely as an example of how some TCP parameters affect connection performance, and does not serve to limit the type and/or number of TCP parameters that may be adjusted/modified by aspects of this disclosure. As an example, embodiments of this disclosure may include modifications to TCP and/or other protocols that increase the number of operational phases. Many TCP protocols initialize with a slow start phase, which may include transmitting packets at a low rate (e.g., one-packet/RTT) and thereafter incrementing the rate (exponentially or otherwise) until a congestion event occurs (or until the transmission is completed). The congestion event may include the failure to receive an ACK message for a transmitted packet (e.g., after a timeout), the reception of a negative acknowledgment (NACK) message, or any other event suggesting that a packet transmission was unsuccessful. The TCP transmission sequence 200 may respond to the congestion event by decrementing the transmission rate to a bottom or floor (e.g., one-packet/RTT) in an attempt to alleviate the perceived congestion. After reaching the bottom or floor, the TCP transmissions sequence 200 may proceed in accordance with a FAST recovery phase, which includes increasing the packet transmission rate (e.g., exponentially or otherwise) for a period of time or until the packet transmission rate reaches a threshold. After the FAST recovery period, the TCP transmissions sequence 200 may proceed in accordance with a congestion avoidance phase, which includes increasing the packet transmission rate at a slower fixed rate for some time period.

Even though the TCP transmissions sequence 200 depicts typical TCP phases, other TCP algorithms may include other phases affecting flow and congestion control. As mentioned above, TCP algorithms can have more phases (or less phases) than the four shown in the TCP transmission sequence 200. That said, TCP algorithms having different characteristics (e.g., parameters, phases, etc.) may attempt to address a common problem of fundamental flow and congestion control in the network.

Considerations when designing a TCP algorithm may include the initial TCP transmission rate, history of similar traffic coming from nearby locations (e.g., as might be stored in a history table), the rate at which the initial transmission rate is increased, which slow start algorithm to implement (if any), information specified in a profile table, which events or criteria constitute a congestion event, to what extent decreasing the TCP transmission rate will mitigate congestion, the rate at which to increase the TCP transmission rate following a congestion condition, what parameters to change (if any upon approaching the past congestion event transmission rate (or whether this rate should be reached at all), etc. One or more of these considerations may depend on the choice of TCP algorithm and the setting of TCP parameters.

In some embodiments, at least some of the responsibility for managing TCP connections may be offloaded from a server to a middlebox. A middlebox may be a source endpoint, and may be configured to dynamically adjust TCP connection parameters and/or history/profile table entries in accordance with in-band signaling received from the destination endpoint. A middlebox may also be a destination endpoint, and may be configured to request or other trigger adjustments to TCP connection parameters and/or history/profile table entries by communicating in-band signaling to the source endpoint.

In some embodiments, a single middlebox may be implemented on the server side of the network. FIG. 3 illustrates an embodiment TCP network architecture 300 over which a middlebox 320 manages TCP connections for carrying data between a plurality of clients 302-304 and one or more servers 360. As shown, the clients 302-304 communicate with the middlebox 320 via TCP connections 312-314 spanning a first network 310, while the middlebox 320 communicates with the server 360 via TCP connections 351-358 spanning a second network 350. In some embodiments, the first network 310 has different characteristics than the second network 350. For instance, the first network 310 may be a high latency network, such as a wide area network (WAN), while the second network 350 may be a low latency network, such as a local area network (LAN). Additionally or alternatively, the first network 310 may be less reliable than the second network 350, as might be the case if the first network 310 is a wireless network and the second network 350 is a wire-line network. The TCP connections 351-358 may include a group of non-persistent TCP connections 351-353 as well as a group of persistent TCP connections 356-358.

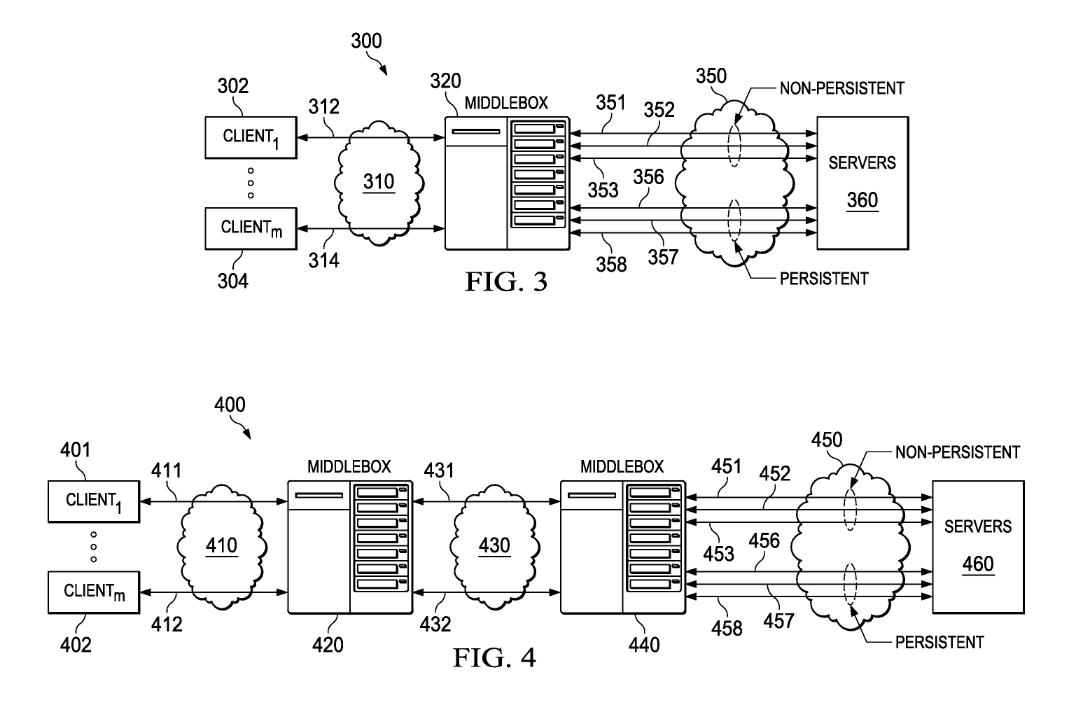

In other embodiments, a middlebox is implemented on the client side as well as the server side. FIG. 4 illustrates an embodiment TCP network architecture 400 over which a pair of middleboxes 420-440 manage TCP connections configured to carry data between a plurality of clients 401-402 and one or more servers 460. As shown, the clients 401-402 communicate with the middlebox 420 via TCP connections 411-412 spanning a first network 410, the middlebox 420 communicates with the middlebox 440 via TCP connections 431-432 spanning a second network 430. Additionally, the TCP connections 431-432 may be persistent or non-persistent connections managed by the middleboxes 420-440 The middlebox 440 communicates with the server 460 via TCP connections 451-458 spanning a third network 450. Additionally, the TCP connections 451-458 may be persistent or non-persistent connections managed by the middleboxes 440.

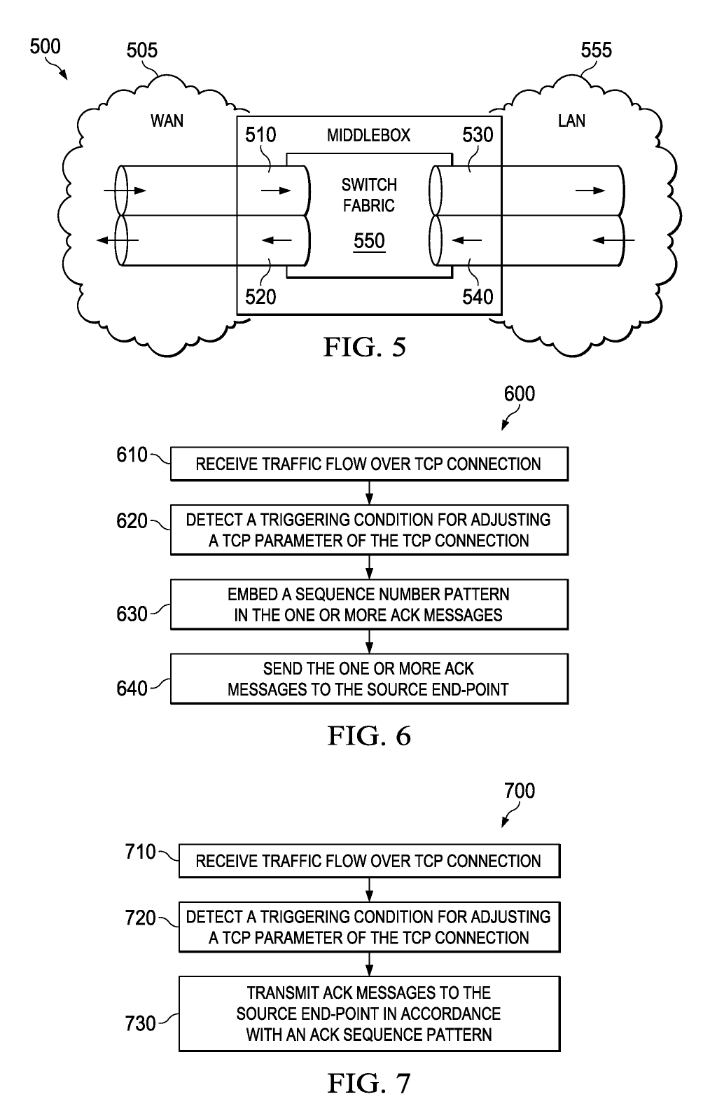

FIG. 5 illustrates an embodiment middlebox 500, as might be implemented in one of the TCP network architectures 300-400. As shown, the middlebox 500 includes an ingress WAN interface 510 and an egress WAN interface 520 for communicating data over a WAN 505, as well as an egress LAN interface 530 and an ingress LAN interface 540 for communicating data over a LAN 555. The middlebox 500 may also include a switching fabric 550 for switching data between the interfaces 510-540.

In-band signaling can be used to request or trigger adjustments to TCP parameters. One technique for achieving in-band signaling is to embed sequence number patterns in ACK messages. FIG. 6 illustrates a method 600 for adjusting TCP parameters through in-band signaling, as may be performed by a destination endpoint. As shown, the method 600 begins with step 610, where the destination endpoint receives a traffic flow over a TCP connection. Next, the method 600 proceeds to step 620, where the destination endpoint detects a triggering condition for adjusting one or more TCP parameters of the TCP connection. Thereafter, the method 600 proceeds to step 630, where the destination endpoint embeds a sequence number pattern in one or more ACK messages. The embedded sequence number pattern may be associated with a triggering condition or with an adjustment of a TCP parameter, and may be interpreted as such by the source endpoint. Subsequently, the method 600 proceeds to step 640, where the destination endpoint sends the one or more ACK messages to the source endpoint.

Another technique for achieving in-band signaling is to transmit ACK messages in accordance with an ACK sequence pattern. FIG. 7 illustrates a method 700 for requesting or triggering adjustment of TCP parameters through in-band signaling, as may be performed by a destination endpoint. As shown, the method 700 begins with step 710, where the destination endpoint receives a traffic flow over a TCP connection. Next, the method 700 proceeds to step 720, where the destination endpoint detects a triggering condition for adjusting a TCP parameter of the TCP connection. Thereafter, the method 700 proceeds to step 730, where the destination endpoint transmits ACK messages to the source endpoint in accordance with an ACK sequence pattern. Transmitting ACK messages in accordance with an ACK sequence pattern may include sending a specified number of duplicate ACK messages (e.g., seven ACKs) or sending an alternating sequence of ACKs (e.g., ACK-1, ACK-2, ACK-1, ACK-2, etc.). Different ACK sequence patterns may be associated with different TCP parameters adjustments and/or triggering conditions. For example, one ACK sequence pattern may request an increase in transmission rate or window size, while another ACK sequence pattern may request an increase in TCP packet size. In some embodiments, the endpoints may transition from a normal mode to an in-band communication mode prior to communicating TCP adjustment requests, which is described in greater detail below.

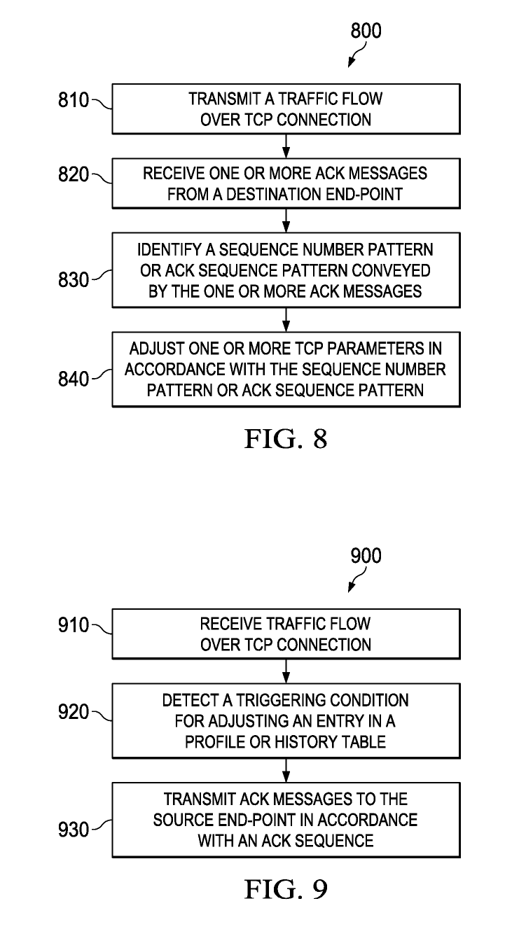

Accordingly, source endpoints may interpret sequence number patterns and/or ACK sequence patterns as a request to adjust TCP parameters (e.g., increase a transmission rate, switch from one TCP congestion algorithm to another, etc.) or as reporting a triggering condition (e.g., a destination network characteristic such as wireless environment, a reordering environment, a fat-pipe environment, etc.). FIG. 8 illustrates a method 800 for adjusting TCP parameters in accordance with in-band signaling, as may be performed by a source endpoint. The method 800 begins with step 810, where the source endpoint transmits a traffic flow over a TCP connection. Thereafter, the method 800 proceeds to step 820, where the source endpoint receives one or more ACK messages from a destination endpoint. Next, the method 800 proceeds to step 830, where the source endpoint identifies a sequence number pattern or an ACK sequence pattern conveyed by one or more of the ACK messages. For instance, the sequence number pattern may be embedded in the one or more ACK messages. Alternatively, the one or more ACK messages may be received in accordance with an ACK sequence pattern, e.g., a given number of duplicate ACKs, an alternating sequence of ACKs, etc. After step 830, the method 800 may proceed to step 840, where the destination endpoint may adjust one or more TCP parameters in accordance with the identified sequence number pattern or ACK sequence pattern.

In-band signaling can also be used to request adjustments to a history or profile table. FIG. 9 illustrates a method 900 for adjusting entries in a history or profile table through in-band signaling, as may be performed by a destination endpoint. As shown, the method 900 begins with step 910, where the destination endpoint receives a traffic flow over a TCP connection. Next, the method 900 proceeds to step 920, where the destination endpoint detects a triggering condition for adjusting an entry in a history or profile table. Thereafter, the method 900 proceeds to step 930, where the destination endpoint transmits ACK messages to the source endpoint in accordance with an ACK sequence pattern. As an alternative to transmitting ACK messages in accordance with an ACK sequence pattern, the destination endpoint may embed a sequence number pattern in the ACK messages prior to sending them to the source endpoint, e.g., in a manner similar to that described in step 630 above. Either way, the ACK sequence pattern or the embedded sequence number pattern is interpreted by the source endpoint as a request to adjust an entry in a history or profile table stored at the source endpoint.

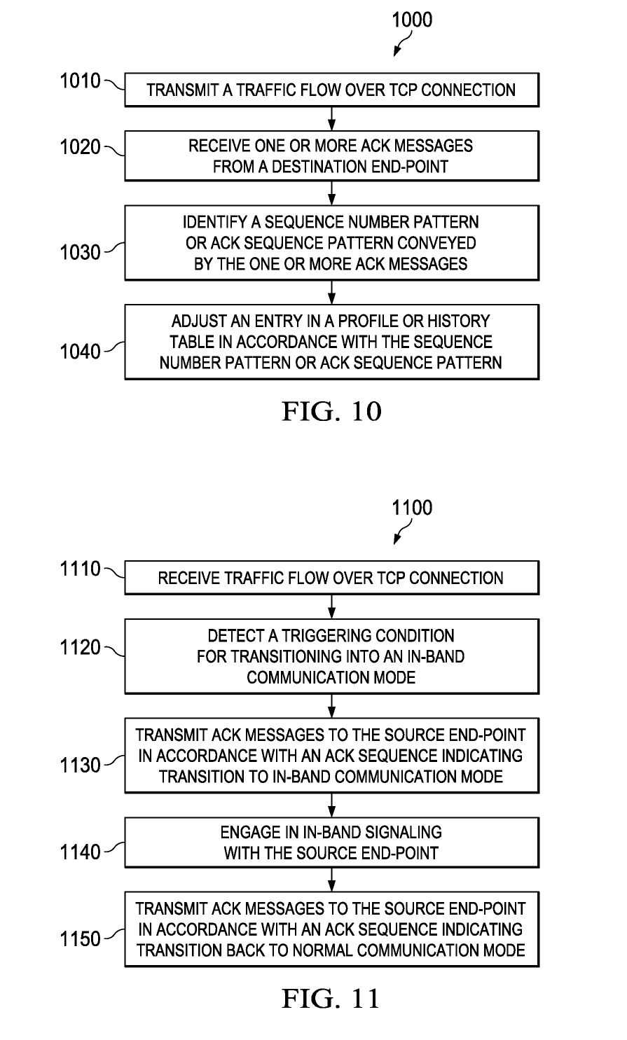

Accordingly, source endpoints may interpret ACK sequence patterns and/or sequence number patterns as requests to adjust history or profile tables. FIG. 10 illustrates a method 1000 for adjusting entries in a history or profile table in accordance with in-band signaling, as may be performed by a source endpoint. The method 1000 begins with step 1010, where the source endpoint transmits a traffic flow over a TCP connection. Thereafter, the method 1000 proceeds to step 1020, where the source endpoint receives one or more ACK messages from a destination endpoint. Next, the method 1000 proceeds to step 1030, where the source endpoint identifies a sequence number pattern or an ACK sequence pattern conveyed by the one or more of the ACK messages. Subsequently, the method 1000 may proceed to step 1040, where the destination endpoint may adjust an entry in a profile or history table in accordance with the sequence number pattern or the ACK sequence pattern.

In some embodiments, endpoints transition from a normal communication mode to an in-band communication mode to achieve more efficient in-band signaling. While in a normal communication mode, the source endpoint may analyze ACKs to determine whether or not a packet was successfully received. While in an in-band communication mode, the source endpoint may analyze ACKs to determine in-band signaling requests/reports, e.g., to adjust TCP parameter, to adjust history/profile table entry, etc.

FIG. 11 illustrates a method 1100 for prompting a source endpoint to transition into an in-band communication mode, as may be performed by a destination endpoint. As shown the method 1100 begins at step 1110, where the destination endpoint receives a traffic flow over a TCP connection. Subsequently, the method 1100 proceeds to step 1120, where the destination endpoint detects a triggering condition for transitioning into an in-band communication mode. Subsequently, the method 1100 proceeds to step 1130, where the destination endpoint transmits ACK messages to the source endpoint in accordance with an ACK sequence pattern. As an alternative, the destination endpoint may embed a sequence number pattern in the ACK messages prior to sending the ACK messages to the source endpoint, e.g., in a manner similar to that described in step 630 above. Either way, the ACK sequence pattern or the embedded sequence number pattern is interpreted by the source endpoint as an indication to transition into the in-band communication mode. Thereafter, the method 1100 proceeds to step 1140, where the destination and source endpoints engage in in-band signaling using one or more of the methods 600-1000 described above. Once in-band signaling is complete, the method 1100 proceeds to step 1150, where the destination endpoint transmits ACK messages to the source endpoint in accordance with an ACK sequence that indicates a transition back to the normal communication mode. Alternatively, the destination endpoint may embed a sequence number pattern in the ACK messages prior to sending them. Either way, the ACK sequence pattern or the embedded sequence number pattern is interpreted by the source endpoint as an indication to transition back into the normal communication mode.

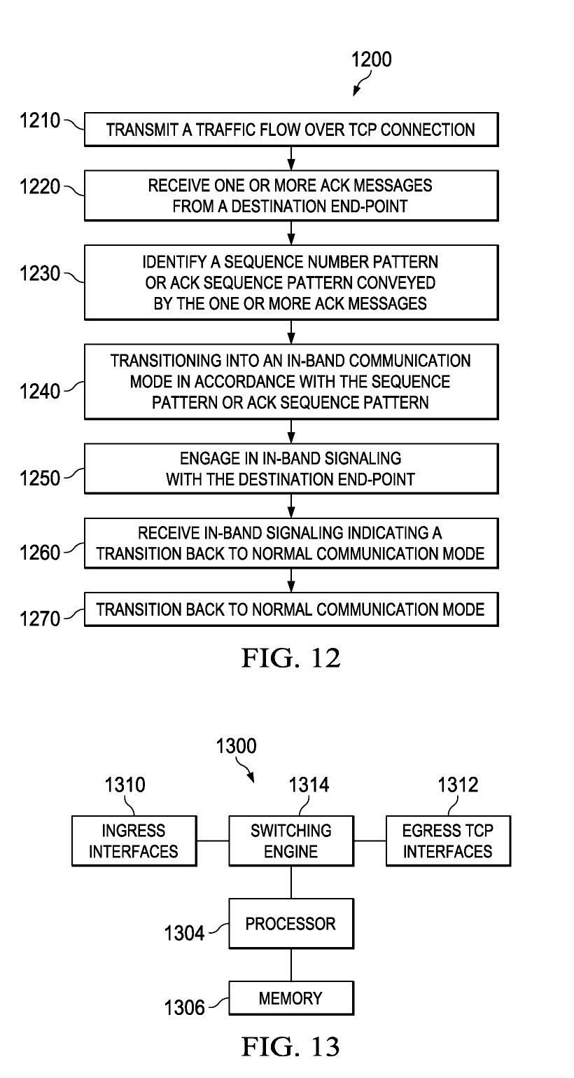

Source endpoints may interpret ACK sequence patterns and/or sequence number patterns as an indication to transition between normal and in-band communication modes. FIG. 12 illustrates a method 1200 for transitioning between normal and in-band communication modes, as may be performed by a source endpoint. As shown, the method 1200 begins at step 1210, where the source endpoint transmits a traffic flow over a TCP connection. Next, the method 1200 proceeds to step 1220, where the source endpoint receives one or more ACK messages from a destination endpoint. Thereafter, the method 1200 proceeds to step 1230, where the source endpoint identifies a sequence number pattern or an ACK sequence pattern conveyed by the one or more ACK messages. Subsequently, the method 1200 proceeds to step 1240, where the source endpoint transitions into an in-band communication mode in accordance with the sequence number pattern or ACK sequence pattern. Thereafter, the method 1200 proceeds to step 1250, where the destination and source endpoints engage in in-band signaling using one or more of the methods 600-1000 described above. Subsequently, and once the in-band signaling is complete, the method 1200 proceeds to step 1260, where the source endpoint receives an ACK sequence pattern or an embedded sequence number pattern indicating a transition back to the normal communication mode. Finally, the method 1200 proceeds to step 1270, where the source endpoint transitions back to normal communication mode.

FIG. 13 illustrates a block diagram of an embodiment of a communications device 1300, which may be equivalent to one or more devices (e.g., middlebox, etc.) discussed above. The communications device 1300 may include a processor 1304, a memory 1306, ingress TCP interfaces 1310, egress TCP interfaces 1312, and a switching engine 1314, a supplemental wireless interface 1312, and a supplemental interface 1310, which may (or may not) be arranged as shown in FIG. 13. The processor 1304 may be any component capable of performing computations and/or other processing related tasks, and the memory 1306 may be any component capable of storing programming and/or instructions for the processor 1304. The ingress TCP interfaces 1310 may be any component or collection of components that allows the communications device 1300 to receive TCP packets, while the egress TCP interfaces 1312 may be any component or collection of components that allows the communications device 1300 to transmit TCP packets. The switching engine 1314 may be any component or collection of components that allows the communications device 1300 to switch TCP packets between the ingress TCP interfaces 1310 and the egress TCP interfaces 1312.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method for in-band signaling, the method comprising:
receiving one or more packets over a transport connection control (TCP) connection extending between a source endpoint and a destination endpoint;
embedding, by the destination endpoint, a sequence number pattern in one or more acknowledgment (ACK) messages, the sequence number pattern being pre-associated with an in-band signaling message; and
sending, by the destination endpoint, the one or more ACK messages to the source endpoint.

2. The method of claim 1, wherein the sequence number pattern is pre-associated with a request, by the destination endpoint, to adjust one or more TCP parameters of the TCP connection.

3. The method of claim 2, wherein the sequence number pattern indicates a request, by the destination endpoint, to adjust a transmission rate of the TCP connection.

4. The method of claim 2, wherein the sequence number pattern indicates a request, by the destination endpoint, to pause transmissions over the TCP connection.

5. The method of claim 2, wherein the sequence number pattern indicates a request, by the destination endpoint, to restart transmissions over the TCP connection.

6. The method of claim 2, wherein the sequence number pattern indicates a request, by the destination endpoint, to switch from a first TCP congestion algorithm to a second TCP congestion algorithm.

7. The method of claim 1, wherein the sequence number pattern is pre-associated with a triggering condition for adjusting one or more TCP parameters of the TCP connection, the triggering condition being reported by the destination endpoint.

8. The method of claim 7, wherein the sequence number pattern indicates a characteristic of a destination network.

9. The method of claim 8, wherein the sequence number pattern indicates that the destination network includes a wireless network environment.

10. The method of claim 1, wherein the sequence number pattern is pre-associated with a request, by the destination endpoint, to adjust an entry in a profile or history table.

11. The method of claim 1, wherein the sequence number pattern instructs the source endpoint to transition into an in-band communication mode.

12. The method of claim 1, wherein the source endpoint is a mobile device, and wherein the sequence number pattern indicates an instant message or an alert for displaying on the mobile device.

13. A method for in-band signaling, the method comprising:
receiving one or more packets over a transport connection control (TCP) connection extending between a source endpoint and a destination endpoint; and
transmitting, by the destination endpoint, acknowledgment (ACK) messages to the source endpoint in accordance with an ACK sequence pattern, wherein the ACK sequence pattern is pre-associated with an in-band signaling message.

14. The method of claim 13, wherein the ACK sequence pattern is pre-associated with a request, by the destination endpoint, to adjust one or more TCP parameters of the TCP connection.

15. The method of claim 14, wherein the ACK sequence pattern indicates at least one of a request to adjust a transmission rate of the TCP connection, a request to pause transmissions over the TCP connection, a request to adjust a TCP packet size, and a request to switch from a first TCP congestion algorithm to a second TCP congestion algorithm.

16. The method of claim 13, wherein the ACK sequence pattern is pre-associated with a triggering condition for adjusting one or more TCP parameters of the TCP connection, the triggering condition being reported by the destination endpoint.

17. The method of claim 13, wherein the ACK sequence pattern is pre-associated with a request, by the destination endpoint, to adjust an entry in a profile or history table.

18. The method of claim 13, wherein the ACK sequence pattern instructs the source endpoint to transition into an in-band communication mode.

19. The method of claim 13, wherein the source endpoint is a mobile device, and wherein the ACK sequence pattern indicates an instant message or an alert for displaying on the mobile device.

20. A device configured as a destination endpoint of a transport connection control (TCP) connection, the device comprising:
a processor; and
a computer readable storage medium storing programming for execution by the processor, the programming including instructions to:
embed a sequence number pattern in one or more acknowledgment (ACK) messages and transmit the ACK messages to a source endpoint; or
transmit acknowledgment (ACK) messages to the source endpoint in accordance with an ACK sequence pattern,
wherein the sequence number pattern or the ACK sequence pattern is pre-associated with an in-band signaling message.

21. The device of claim 20, wherein the sequence number pattern or the ACK sequence pattern is pre-associated with a request, by the destination endpoint, to adjust one or more TCP parameters of the TCP connection.

22. The device of claim 20, wherein the sequence number pattern or the ACK sequence pattern is pre-associated with a triggering condition for adjusting one or more TCP parameters of the TCP connection, the triggering condition being reported by the destination endpoint.

23. The device of claim 20, wherein the sequence number pattern or the ACK sequence pattern is pre-associated with a request, by the destination endpoint, to adjust an entry in a profile or history table.

24. The device of claim 20, wherein the sequence number pattern instructs the source endpoint to transition into an in-band communication mode.

25. The device of claim 20, wherein the source endpoint is a mobile device, and wherein the sequence number pattern indicates an instant message or an alert for displaying on the mobile device.

26. A method for in-band signaling, the method comprising:
transmitting, by a source endpoint, one or more packets over a transport connection control (TCP) connection extending between the source endpoint and a destination endpoint;
receiving, by the source endpoint, one or more acknowledgment (ACK) messages; detecting, by the source endpoint, a sequence number pattern or an ACK sequence pattern conveyed by the one or more ACK messages; and
determining, by the source endpoint, an in-band signaling message pre-associated with either the sequence number pattern or the ACK sequence pattern.

27. The method of claim 26, wherein the sequence number pattern or the ACK sequence pattern is pre-associated with a request, by the destination endpoint, to adjust one or more TCP parameters of the TCP connection.

28. The method of claim 26, wherein the sequence number pattern or the ACK sequence pattern is pre-associated with a triggering condition for adjusting one or more TCP parameters of the TCP connection, the triggering condition being reported by the destination endpoint.

29. The method of claim 26, wherein the sequence number pattern or the ACK sequence pattern is pre-associated with a request, by the destination endpoint, to adjust an entry in a profile or history table.

30. The method of claim 26, wherein the sequence number pattern or the ACK sequence pattern instructs the source endpoint to transition into an in-band communication mode.

31. The method of claim 26, wherein the source endpoint is a mobile device, and wherein the sequence number pattern or the ACK sequence pattern indicates an instant message or an alert for displaying on the mobile device.

32. A device configured as a source endpoint of a transport connection control (TCP) connection, the device comprising:
a processor; and
a computer readable storage medium storing programming for execution by the processor, the programming including instructions to:
transmit one or more packets over a TCP connection extending between the source endpoint and a destination endpoint;
receive one or more acknowledgment (ACK) messages;
detect a sequence number pattern or an ACK sequence pattern conveyed by the one or more ACK messages; and
determine an in-band signaling message pre-associated with the sequence number pattern or the ACK sequence pattern.

33. The device of claim 32, wherein the sequence number pattern or the ACK sequence pattern is pre-associated with a request, by the destination endpoint, to adjust one or more TCP parameters of the TCP connection.

34. The device of claim 32, wherein the sequence number pattern or the ACK sequence pattern is pre-associated with a triggering condition for adjusting one or more TCP parameters of the TCP connection, the triggering condition being reported by the destination endpoint.

35. The device of claim 32, wherein the sequence number pattern or the ACK sequence pattern is pre-associated with a request, by the destination endpoint, to adjust an entry in a profile or history table.

36. The device of claim 32, wherein the sequence number pattern or the ACK sequence pattern instructs the source endpoint to transition into an in-band communication mode.

37. The device of claim 32, wherein the source endpoint is a mobile device, and wherein the sequence number pattern or the ACK sequence pattern indicates an instant message or an alert for displaying on the mobile device.
